(19) United States
(12) Patent Application Publication
(10) Pub. No.: US 2025/0218616 A1
(43) Pub. Date: Jul. 3, 2025

(54) METHOD OF CONTINUOUS MANUFACTURING OF ACTINIUM-225 FROM A RADIUM GENERATOR

(71) Applicant: BWXT Medical Ltd., Ottawa (CA)

(72) Inventors: Blake TAMBOLINE, Vancouver (CA); Patrick Causey, Kanata (CA); Michael Wong, Vancouver (CA); Alexander K. Lee, Vancouver (CA)

(21) Appl. No.: 19/002,194

(22) Filed: Dec. 26, 2024

Related U.S. Application Data
(60) Provisional application No. 63/615,160, filed on Dec. 27, 2023.

(51) Int. Cl. G21G 1/04; B01D 15/18; B01D 15/36; G21G 1/00

(52) U.S. Cl. CPC G21G 1/04; B01D 15/1871; B01D 15/1894; B01D 15/362; G21G 2001/0089

(57) ABSTRACT

A method is provided of continuous manufacturing of Actinium-225 from a radium generator by repeating chemical purification is provided.

### CROSS-REFERENCE TO RELATED APPLICATION

This application claims priority from U.S. Provisional Patent Application No. 63/615,160 filed on Dec. 27, 2023, in the United States Patent and Trademark Office. The disclosure of which is incorporated herein by reference in its entirety.

### FIELD OF THE INVENTION

The present invention relates to a method for producing Actinium-225, more particularly to a method for producing Actinium-225 from proton spallation of natural thorium targets via a radium generator.

### BACKGROUND OF THE INVENTION

There are existing processes for isolation and recovery of isotopes of radium and actinium. Interest in Ac-225 as a radiotherapeutic isotope has been steadily growing over the past three decades. Despite its notable success in pre-clinical research, early phase clinical studies, and compassionate care market, commercial realization has been limited due to the availability of the required source materials, technological challenges, and barriers to entry associated with licensing and waste management. Early use of Ac-225 was made available from decay of Th-229, through Ra-225. However, as Th-229 results from the decay of the strategic, controlled, fissile material U-233, availability of Ac-225 from this route has been limited. Furthermore, this technology is not scalable and has stimulated the search for alternative sources of clinical grade Ac-225.

One such technology that is scalable, is high energy proton spallation of natural thorium. The result of this process is the coproduction of 1000's of isotopes, covering almost the entirety of the periodic table. The unwanted co-production of Ac-227, a long-lived beta emitter, has made the use of directly produced Ac-225 untenable for clinical application. However, pure Ac-225 can be obtained from a Ra-225 generator, exploiting the direct production of the parent isotope by spallation at high energy. The National Accelerator Laboratory in Canada, TRIUMF, houses an accelerator that is sufficiently energetic to enable this technology, along with a dedicated Isotope Production Facility (IPF) at the end of cyclotron beam line IA.

However, there are limitations associated with such methods. There is a need for a method that overcomes the disadvantages of known methods.

### SUMMARY OF THE INVENTION

The present invention relates to a method of continuous manufacturing of Actinium-225 from a radium generator. A method for the continuous manufacturing of Ra-225 generators, the parent isotope and radiochemical precursor for high purity Ac-225 is provided. A method for the radiochemical processing for construction of the Radium-225 generator and the subsequent milking to produce the final, distributed product is provided.

In an aspect of the invention, a method for manufacturing a radium generator is provided. The method comprises: dissolving a target comprising Thorium metal to form a target solution; evaporating of the target solution thereby generating isolated dried Thorium salt; reconstituting the isolated dried Thorium salt; conducting cation exchange chromatography for bulk Thorium removal; conducting extraction chromatography; conducting eluent evaporation; conducting in-process radium reconstitution; and conducting cation exchange chromatography for barium removal, thereby forming the radium generator.

In an aspect of the invention, the Thorium metal is in sheet form.

In an aspect of the invention, the Thorium metal sheet is at or greater than 99.6% Thorium by mass.

In an aspect of the invention, a method for continuous generator manufacturing reprocessing is provided. The method comprises: combining radium generators; evaporating; conducting ²²⁵Ra reconstitution; conducting extraction column chromatography; diluting of in-process ²²⁵Ra; and forming of ²²⁵Ra generator.

In an aspect of the invention, the method further comprises Actinium milking. The method of Actinium milking comprises: conducting extraction column chromatography, diluting, conducting subsequent extraction chromatography, and evaporating thereby resulting in [²²⁵Ac]AcCl₃ dried salt.

Further areas of applicability of the present invention will become apparent from the detailed description provided hereinafter. It should be understood that the detailed description and specific examples, while indicating the preferred embodiments of the invention, are intended for purposes of illustration only and are not intended to limit the scope of the invention.

### BRIEF DESCRIPTION OF THE DRAWINGS

The present invention will become more fully understood from the detailed description and the accompanying drawings, which are not necessarily to scale and are incorporated by reference herein in their entireties.

FIG. 1 is a flow diagram illustrating a method for manufacturing a radium generator in accordance with an aspect of the invention.

FIG. 2 is a flow diagram illustrating a method for continuous manufacturing of a Ra-225 generator in accordance with an aspect of the invention.

FIG. 3 is a flow diagram illustrating a method for Actinium milking in accordance with an aspect of the invention.

### DESCRIPTION OF THE PREFERRED EMBODIMENTS

The following description of the embodiments of the present invention is merely exemplary in nature and is in no way intended to limit the invention, its application, or uses. The following description is provided herein solely by way of example for purposes of providing an enabling disclosure of the invention, but does not limit the scope or substance of the invention.

Further, the term “or” as used in this disclosure and the appended claims is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form. Throughout the specification and claims, the following terms take at least the meanings explicitly associated herein, unless the context dictates otherwise. The meanings identified below do not necessarily limit the terms, but merely provide illustrative examples for the terms. The meaning of “a,” “an,” and “the” may include plural references, and the meaning of “in” may include “in,” “at,” and/or “on,” unless the context clearly indicates otherwise. The phrase “in one embodiment,” as used herein does not necessarily refer to the same embodiment, although it may.

The present invention relates to a radiochemical separation method for producing Actinium-225 (Ac-225) from proton spallation of natural thorium targets via a radium generator. Spallation reactions are processes in which a heavy nucleus emits numerous nucleons through inelastic nuclear reactions as a result of being hit by a high-energy particle. Multiple radioisotopes of most elements of the periodic table are generated in the thorium spallation reaction.

The method of the present invention produces a radium generator from an irradiated thorium source for the purpose of producing high quality Actinium-225 (Ac-225), a therapeutic radioisotope. This patent application incorporates by reference, in its entirety, commonly owned U.S. patent application Ser. No. 18/397,136, filed Dec. 27, 2023.

A radium generator is a radionuclide device that produces a short-lived medical radionuclide (known as “daughter”) from the radioactive transformation of a longer-lived radionuclide (called a “parent”). The generator permits ready separation of the daughter radionuclide from the parent. The generator device (sometimes referred to as a “cow”) typically provides opportunity for repeated separations of the daughter product. This separation process is called an elution (also referred to as a “milking”).

With the method of the present invention, a radium generator can be radiochemically isolated with minimal bulk thorium content, and with essentially no Ac-227 presence. The method of the present invention is highly effective for quickly and efficiently constructing a radium generator that is capable for subsequently producing high quality Ac-225, particularly suitable for therapeutic use.

The method of the present invention generally comprises construction of a radium generator, continuous manufacturing of Ra-225 generator, and “milking” of the generator.

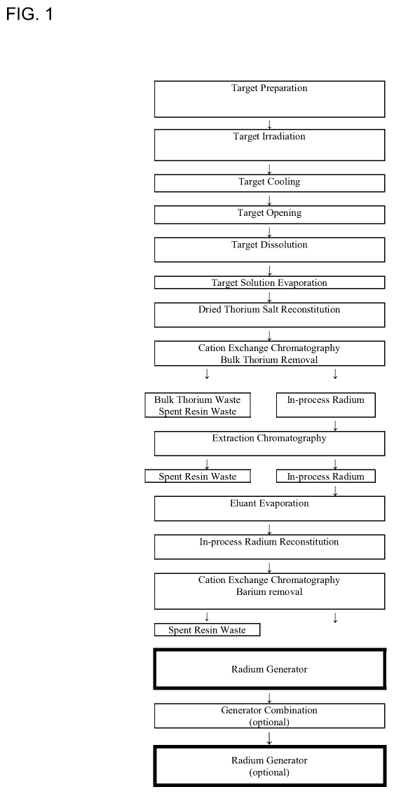

Referring to the figures, FIG. 1 is a flow diagram illustrating a method for manufacturing a radium generator in accordance with an aspect of the invention. The method of the present invention for the construction or manufacture of the radium generator generally comprises: dissolving a target comprising Thorium metal thereby forming a target solution; evaporating of the target solution thereby generating isolated dried Thorium salt; reconstituting the isolated dried Thorium salt; conducting cation exchange chromatography for bulk Thorium removal; conducting extraction chromatography of in-process radium; conducting eluent evaporation of in-process radium; conducting in-process radium reconstitution; and conducting cation exchange chromatography for barium removal and/or tracer quantities of radioimpurities, thereby forming the radium generator.

The method for the construction or manufacture of the radium generator may comprise one or more method steps prior to dissolution of the target such as preparation of the target wherein the target comprises Thorium metal, irradiation of the target, cooling of the irradiated target, and/or opening of the cooled target. The Thorium metal may be in any form. For example, Thorium can be obtained in metal sheet form. The Thorium metal sheets are preferably at or greater than 99.6% Thorium by mass.

Cation exchange chromatography for bulk Thorium removal can use input materials including, but not limited to, sulfuric acid, nitric acid, water, a cation exchange resin, and a combination thereof. The reconstituted target solution is loaded directly onto the cation exchange resin with unretained bulk Thorium passing directly through the column in the mobile phase, and allowing for temporary retention of radium isotopes (and other radioimpurities) onto the solid phase resin. Following bulk thorium separation, the in-process radium is present in the nitric acid elution fraction, for example. The load fraction, containing bulk Thorium, is subsequently diverted to the liquid waste stream, while the spent cation exchange resin following the elution steps is directed to the solid waste stream.

Following the successful construction of the radium generator by the removal of unwanted alkaline metals, the desired, purified radium fraction is stored. This fraction is suitable for intermediate storage as a radium generator, allowing for ingrowth of Actinium-225 from decay of Radium-225, followed by continuous manufacturing of Ra-225 generator, and/or milking.

In an aspect of the invention, a method for continuous generator manufacturing reprocessing is provided. A continuously manufactured Radium generator refers to the combination of conforming Radium generators, and the subsequent reprocessing of these combined Radium generators to produce a single Radium generator. Reprocessing resets the expiry of the generator. The method results in an extension of shelf life. This also results in additional product and manufacturing efficiencies, reduced labor and waste.

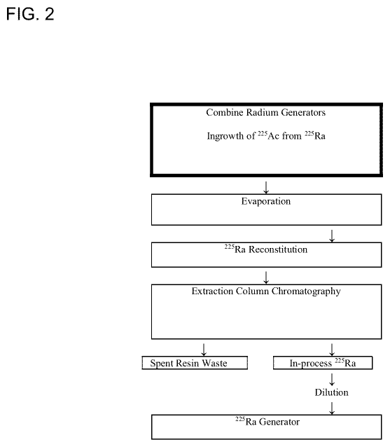

FIG. 2 is a flow diagram illustrating a method for continuous manufacturing of a Ra-225 generator in accordance with an aspect of the invention. The method for continuous generator manufacturing reprocessing generally comprises: combining radium generators; evaporation of combined Radium Generator solution; ²²⁵Ra reconstitution; extraction column chromatography; dilution of in-process ²²⁵Ra; and formation of ²²⁵Ra generator.

As indicated above, the method begins with the combination of conforming Radium generators. The material inputs into the combined Radium generator can be a Radium generator that is unexpired. The combined Radium generator solution is evaporated, to allow for controlled solution volume for the column chromatography. The material inputs for this step include compressed air and water. After the evaporation is complete, the dried Radium generator is reconstituted. Extraction column chromatography is performed using resins to reprocess the solution ensuring control over impurities. Impurities remain on the extraction column and are considered spent resin waste. The resulting radium solution is then diluted with purified water to achieve the established generator normality. Additional reagents used can include nitric acid and process water. The resulting Radium generator is typically collected in a new storage vessel. In-growth of ²²⁵Ac from the Radium generator is defined by the half-lives of ²²⁵Ac (9.92d) and ²²⁵Ra (14.92d) and the initial activity of ²²⁵Ra in the generator. Mathematically, it is described by the following equation;

$${A}_{AC - 225} = 2.97 * {A}_{Ra - 225} * ( ( EXP ( - 0.046 * t ) - ( EXP ( - 0.07 * t ) ) ) ,$$

where A_{Ac-225} is the activity of ²²⁵Ac, A_{Ra-225} is the initial activity of ²²⁵Ra, and t is the elapsed ingrowth time in days.

Upon the realization of the required in-growth period, in-process ²²⁵Ac is milked from the Radium generator solution.

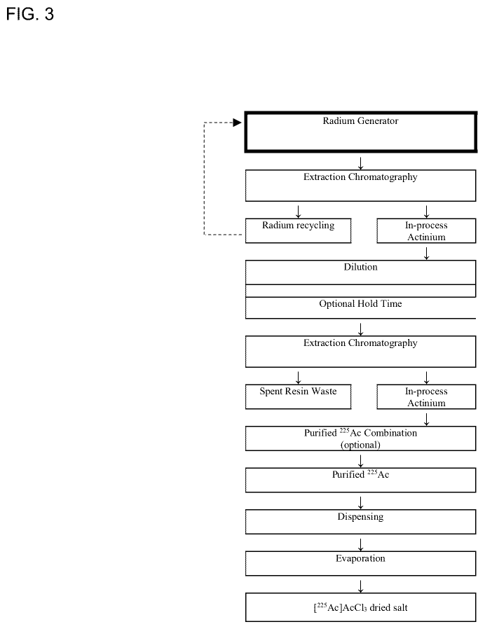

FIG. 3 is a flow diagram illustrating a method for Actinium milking in accordance with an aspect of the invention. Milking may generally comprise the following steps: extraction chromatography, dilution, and a subsequent extraction chromatography, and final product evaporation resulting in [²²⁵Ac]AcCl₃ dried salt.

As shown in FIG. 3, upon the realization of the in-growth period, in-process ²²⁵Ac is milked from the Radium Generator solution.

The Radium Generator is passed through an extraction chromatography resin. Examples of input materials include, but are not limited to, nitric acid and/or hydrochloric acid. The resin is used to absorb in-grown actinium, along with other +3 lanthanides.

The in-process actinium is retained by the extraction chromatography resin with in-process radium from the Radium Generator passing directly through the resin for subsequent ingrowth and repeated milking. The Radium Generator is not re-tested for re-release up until the point of expiry whereby the retired generator is diverted to the liquid waste stream.

Selective removal of the in-process actinium may be accomplished, for example, by elution in high molar nitric acid, following a washing step to remove stable and radioactive Pb, using mid molar hydrochloric acid. The spent resins, still retaining lanthanides present in the Radium Generator, are directed to the solid waste stream.

The eluted in-process actinium fraction is subsequently diluted with water in the dilution step.

After the dilution of the in-process actinium fraction, there is an optional hold period of the in-process Actinium. This hold step maybe optional for the production of actinium from a Radium Generator. The hold time is to control for the potential grow in of the impurity ²²⁸Th (t1/2=1.91y), which is a daughter of ²²⁸Ac (t1/2=6.13h). The impurity is given time to grow in, allowing it to be removed by the subsequent extraction chromatography step.

Following dilution, the in-process actinium is further polished by extraction chromatography resins followed by concentration. Additional reagents may include, for example, nitric and hydrochloric acid and process water.

Purified ²²⁵Ac from multiple Radium Generators may be combined.

The purified ²²⁵Ac solution eluted from resin in the preceding step may be controlled by the material specifications.

Following release of ²²⁵Ac, the liquid product is dispensed.

Evaporation of the dispensed ²²⁵Ac product is performed.

Testing and release of final product [²²⁵Ac]AcCl₃ dried salt can occur.

Ingrowth of Ac-225 from decay of Ra-225 is simultaneously affected by the decay of Ac-225, allowing the generator system to reach equilibrium within a couple of weeks, however milking, or radiochemical separation of Ac-225 at earlier time points allows for increased overall production of the isotope.

The method of the present invention generally comprises deliberate and controlled introduction of conforming radium cow(s) back into the manufacturing process by repeating existing chemical purification step(s). It is performed for a majority of batches and therefore is part of the manufacturing process (continuous manufacturing or “CM”).

Production of a radium generator comprises a series of manufacturing steps. 225Ac is produced from the radium generator by decay of ²²⁵Ra. The “milking” frequency of the radium generator is thus an important consideration in regard to total 225Ac supply.

It will therefore be readily understood by those persons skilled in the art that the present invention is susceptible of broad utility and application. Many embodiments and adaptations of the present invention other than those herein described, as well as many variations, modifications and equivalent arrangements, will be apparent from or reasonably suggested by the present invention and the foregoing description thereof, without departing from the substance or scope of the present invention. Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements.

What is claimed is:

1. A method for manufacturing a radium generator, the method comprising:
dissolving a target comprising Thorium metal to form a target solution;
evaporating of the target solution thereby generating isolated dried Thorium salt;
reconstituting the isolated dried Thorium salt;
conducting cation exchange chromatography for bulk Thorium removal;
conducting extraction chromatography;
conducting eluent evaporation;
conducting in-process radium reconstitution; and
conducting cation exchange chromatography for barium removal, the method thereby forming the radium generator.

2. The method according to claim 1, further comprising continuous generator manufacturing reprocessing.

3. The method according to claim 2, wherein continuous generator manufacturing reprocessing comprises:
combining Radium generators to form a combined Radium generator;
evaporating;
conducting ²²⁵Ra reconstitution;
conducting extraction column chromatography;
diluting in-process ²²⁵Ra; and
forming of ²²⁵Ra generator.

4. The method according to claim 2, further comprising Actinium milking.

5. The method according to claim 4, wherein Actinium milking comprises:
conducting extraction column chromatography,
diluting,
conducting subsequent extraction chromatography, and
evaporating thereby resulting in [²²⁵Ac]AcCl₃ dried salt.

6. The method according to claim 3, wherein a material input into the combined Radium generator is an unexpired Radium generator.

7. The method according to claim 1, wherein the Thorium metal is in sheet form.

8. The method according to claim 7, wherein the Thorium metal sheet is at or greater than 99.6% Thorium by mass.

9. A method for continuous generator manufacturing reprocessing, the method comprising:
combining radium generators;
evaporating;
conducting ²²⁵Ra reconstitution;
conducting extraction column chromatography;
diluting of in-process ²²⁵Ra; and
forming of ²²⁵Ra generator.

10. The method according to claim 9, further comprising Actinium milking.

11. The method according to claim 10, wherein Actinium milking comprises:
conducting extraction column chromatography,
diluting,
conducting subsequent extraction chromatography, and
evaporating thereby resulting in [²²⁵Ac]AcCl₃ dried salt.

12. A method for the Actinium milking, the method comprising:
conducting extraction column chromatography,
diluting,
conducting subsequent extraction chromatography, and
evaporating thereby resulting in [²²⁵Ac]AcCl₃ dried salt.
